(19) United States
(12) Patent Application Publication
(10) Pub. No.: US 2023/0259644 A1
(43) Pub. Date: Aug. 17, 2023

(54) METHOD AND SYSTEM FOR SHARING INFORMATION VIA WEARABLE ELECTRONICALLY READABLE IDENTIFIERS

(71) Applicant: Sophia Marie Jappinen, Avon, CT (US)

(72) Inventor: Sophia Marie Jappinen, Avon, CT (US)

(21) Appl. No.: 18/167,840

(22) Filed: Feb. 11, 2023

Related U.S. Application Data
(60) Provisional application No. 63/309,626, filed on Feb. 13, 2022.

(51) Int. Cl. G06F 21/60; G06F 21/31

(52) U.S. Cl. CPC G06F 21/604; G06F 21/31; G06F 2221/2141

(57) ABSTRACT

A method for sharing information of a wearable attire. The method comprising providing an electronically readable identifier embedded on the wearable attire, scanning, by means of an electronically reading device by a user, the electronically readable identifier embedded on the wearable attire as the wearable attire is brought into its proximity, accessing, information and data pertaining to the wearable attire, by scanning the electronically readable identifier embedded on the wearable attire, providing the information and data pertaining to the wearable attire to a data processing device which subsequently processes said data, and creating a user profile, for the first-time user, on a software application on the electronically reading device. The method further comprises signing, by the user, into the user profile on the software application and claiming ownership of the wearable attire by multiple consecutive scanning of the electronically readable identifier embedded on the wearable attire.

### CROSS-REFERENCE TO RELATED APPLICATIONS

The present application is a U.S. Non-Provisional Utility Pat. Application that claims the benefit of U.S. Provisional Pat. Application No. 63/309,626, entitled “Application and Method of Use for Sharing Information in Relation to Wearable Attire,” filed Feb. 13, 2022; the entire disclosure of which is incorporated herein by reference.

### BACKGROUND OF THE INVENTION

Wearable attire is generally specific purpose clothing that has little or no information pertaining to its origin, location, intention, purpose, etc. This restriction makes it difficult to serve a purpose or intention that encourages or inspires the wearer to greater self-awareness, blissful acts of kindness, appreciation for others, or even charitable causes.

It is known in the art to temporarily provide wearable attires such as garments with identification tags, in particular, while they are presented in stores, for example as an anti-theft device. Then, as soon as the garment is sold from the store, the tag is removed and no further data is collected for the rest of the lifetime of the garment. Thus, by removing the identification tag from the garment, extensive possibilities for collecting data related to the use and lifecycle of the garment are lost. However, from collecting and processing data over the entire lifetime of the garment not only the producer, distributor and retailer of the garment could benefit but also the owner of the garment.

The garment is provided with an electronically readable identification tag in a permanent manner, on which tag the identification data of the garment is stored, an electronic reading device is arranged to read out the information data from the tag as the garment is brought into its proximity, and the data processing device which is arranged to receive said identification data from the reading device and process said identification data.

However, the prior techniques and applications used for the previous scenario, do not effectively provide solutions to this problem, as they consist of insubstantial applications and methods of use, that are susceptible to inaccessible means and inabilities and limiting device capabilities and capacities.

Therefore, what is needed are techniques that overcome the above-mentioned disadvantages and problems.

### SUMMARY OF THE INVENTION

To address the foregoing problems, in whole or in part, and/or other problems that may have been observed by persons skilled in the art, the present disclosure provides compositions and methods as described by way of example as set forth below.

It is an object of the invention to provide a simple and efficient method and system for sharing information of a wearable attire.

It is another object of the invention to provide a method and system for sharing information of a wearable attire by which a user can claim ownership of the wearable attire.

It is another object of the invention to provide a method and system for sharing information of a wearable attire by which a wearable attire of a user can be entangled with the wearable attire of another user.

It is another object of the invention to provide a method and system for sharing information of a wearable attire by which ownership of a wearable attire can be transferred to another user.

In a preferred embodiment, the present invention consists of a mobile application and method of use which allows specific data and information regarding specific wearable attire, to be linked, shared, and viewed by the wearers. The present invention is also comprised of a stitched and tagged QR code that can be scanned by a smartphone, allowing the wearers to access this information and data pertaining to particular wearable attire. This assists the wearers to feel more connected to what they wear and what they intend to be. It can also help a wearer to feel more connected to other wearers that may be linked to their wearable attire, through a process referred to as entanglement. Entanglement allows two or more wearers to be linked together through two or more separate wearable attire components. The entangled wearers can bestow personal messages and communications to one another. The present invention allows wearers to be more aware of the intention of their clothing, entanglement, location, origin, etc.

According to an embodiment of the present disclosure, there is provided a method for sharing information of a wearable attire. The method comprising providing an electronically readable identifier embedded on the wearable attire, scanning, by means of an electronically reading device by a user, the electronically readable identifier embedded on the wearable attire as the wearable attire is brought into its proximity, accessing, information and data pertaining to the wearable attire, by scanning the electronically readable identifier embedded on the wearable attire, providing the information and data pertaining to the wearable attire to a data processing device which subsequently processes said data, and creating a user profile, for the first-time user, on a software application on the electronically reading device. The method further comprises signing, by the user, into the user profile on the software application and claiming ownership of the wearable attire by multiple consecutive scanning of the electronically readable identifier embedded on the wearable attire.

According to an embodiment of the present disclosure, there is provided a system for sharing information of a wearable attire. The system comprises an electronically readable identifier embedded on the wearable attire configured to be scanned by means of an electronically reading device by a user as the wearable attire is brought into its proximity, a data processing device configured to subsequently process the information and data pertaining to the wearable attire, received by scanning the electronically readable identifier embedded on the wearable attire, and a software application configured to support a user profile of the user. The disclosed system further comprises claiming ownership of the wearable attire by multiple consecutive scanning of the electronically readable identifier embedded on the wearable attire and signing into the software application.

Additional features of the invention will be or will become apparent to one with skill in the art upon examination of the following figures and detailed description. It is intended that all such additional features and advantages be included within this description, be within the scope of the invention, and be protected by the accompanying claims.

### BRIEF DESCRIPTION OF DRAWINGS

Having thus described the subject matter of the present invention in general terms, reference will now be made to the accompanying drawings, which are not necessarily drawn to scale.

FIG. 1 illustrates a flowchart of an embodiment of the user processes and methods of use within the present invention, in accordance with an embodiment of the present disclosure.

FIGS. 2a-2b illustrates a flowchart of an embodiment of the user processes and methods of use within the present invention, in accordance with an embodiment of the present disclosure.

### DETAILED DESCRIPTION OF THE INVENTION

The subject matter of the present invention now will be described more fully hereinafter with reference to the accompanying drawings, in which some, but not all embodiments of the subject matter of the present invention are shown. Like numbers refer to like elements throughout. The subject matter of the present invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the present invention pertains having the benefit of the teachings presented in the foregoing descriptions and the associated drawings. Therefore, it is to be understood that the subject matter of the present invention is not to be limited to the specific embodiments disclosed and that modifications and other embodiments are intended to be included within the scope of the appended claims.

### System and Method for Sharing Information Via Wearable Electronically Readable Identifiers

The present invention provides a method and a system for sharing information of a wearable attire.

In the present invention, there is provided a method for sharing information of a wearable attire. The method comprising providing an electronically readable identifier embedded on the wearable attire, scanning, by means of an electronically reading device by a user, the electronically readable identifier embedded on the wearable attire as the wearable attire is brought into its proximity, accessing, information and data pertaining to the wearable attire, by scanning the electronically readable identifier embedded on the wearable attire, providing the information and data pertaining to the wearable attire to a data processing device which subsequently processes said data, and creating a user profile, for the first-time user, on a software application on the electronically reading device. The method further comprises signing, by the user, into the user profile on the software application and claiming ownership of the wearable attire by multiple consecutive scanning of the electronically readable identifier embedded on the wearable attire.

According to an embodiment of the present disclosure, the method comprises entangling the wearable attire of the user with the wearable attire of another user upon scanning the electronically readable identifier embedded on the wearable attire of another user.

In the process of entangling a wearable attire of a user with the wearable attire of another user, a user scans the electronically readable identifier embedded on the wearable attire of another user for sending an entanglement request to another user of the wearable attire on the user profile on the software application of the another user. Another user receives an entanglement request on the software application under his user profile and the another user accepts the same for completing the entanglement of the two wearable attire.

According to an embodiment of the present disclosure, alternatively, entangling a wearable attire of a user with the wearable attire of another user can be done by selecting the wearable attire out of an inventory under the user profile on the software application on the electronically reading device.

Below mentioned are the types of entanglements:

### (I) Exclusive Entanglements

Requested entanglements can be one-to-one or exclusive in nature. Some kinds of entanglements are meant to be between two units:

Examples:
Monogamous Relationship
Best friend
Exclusive Titles

### (II) Non-Exclusive Entanglements

Requested entanglements can be one to many or many to many:

Examples:
Friendships
Membership in a group

### (III) Static Entanglements

Teams
Limited Edition
Bulk order

### (IV) Pre-Release Process

Limited edition release
Bulk order customization

### (V) Post-release Process

Have an entangle wear account

According to an embodiment of the present disclosure, the information and the data pertaining to the wearable attire comprises a unique identifier, a model, a size, measurements, a material and/or fabric, care instructions, a colour, a style and/or an origin of the wearable attire, entanglement status, user details, and historic record of data events associated with the wearable attire.

Further, the information and the data pertaining to the wearable attire comprises product profiles such as product description, limited batch/run number, Owner(s) - i.e. users, claim/transfer date, transfer message, message/Intention/Blessing (created once, or once per transfer), status (a short message that can change, but it replaces).

According to an embodiment of the present disclosure, the information and the data pertaining to the wearable attire comprises user profiles such as user Identity -message/bio, collect the products they own, and track to whom they are entangled.

According to an embodiment of the present disclosure, the user profile on the software application provides alerts and information to the user regarding what people are wearing; auto-entangling limited custom cohorts, information regarding limited edition products, school class (graduation), jobs, churches, charities, and various events.

Further, the user profile on the software application provides various provisions like when the user signs in to the user profile with google/Facebook/etc., Open Authorization user can then manage their wearable attire from the user profile itself including transferring them. The following information can be also associated with the user profile, such as owner/owner history (heritage), and messages like gift messages, intentions, and declarative blessings. Further, the user profile provides information on the history of entanglements. Under the user profile on the software application, the limited edition products can be tracked like lithographs, and it also facilitates creating cohorts which are a type of entanglement and exploring of the cohorts. When a unit that is owned and setup is scanned any user can view that profile and associated cohorts and entanglements.

According to an embodiment of the present disclosure, the method comprising claiming ownership of the wearable attire by entering a unique secret code, on the software application, associated with the wearable attire.

A secret code is packaged with the wearable attire in such a way that it is not visible unless the package has been opened. The secret is often further obscured on the card it is printed on with a scratch-off film or coating. This secret can be used at any time to take possession of the unit and does not require the permission of any kind. The secret code is required to be kept secret and safe. The secret code can be entered on the user profile on the software application or website to take possession of the wearable attire at any time without any kind of additional permissions or verification.

According to an embodiment of the present disclosure, the method comprising preventing an adverse possession by locking the ownership of the wearable attire on the user profile.

An owner can prevent adverse possession by locking the ownership of a unit on the profile. The ownership can then only be ‘claimed’ by another by unlocking the ownership at which point the unit can be reclaimed by use of a secret key or by adverse possession.

According to an embodiment of the present disclosure, the method comprising transferring the ownership of the wearable attire by selecting a transfer option on the software application or by scanning the electronically readable identifier on the wearable attire of another user and selecting the wearable attire for which the ownership has to be transferred.

Whoever owns a unit can initiate a transfer process within the software application or on the website. The user can select a unit and select the transfer option and provide and email of the person to transfer it too. Alternatively, the person can scan the unit of another individual and select an item to transfer to that user/person.

According to an embodiment of the present disclosure, a ‘claimant’ can claim a unit by scanning the identifier on the unit for some number of consecutive days. Once the ‘claimant’ has taken adverse possession of a unit, the claimant can take control of the online profile for the unit and its entanglement status.

According to an embodiment, the invention provides a system for sharing information of a wearable attire. The system comprises an electronically readable identifier embedded on the wearable attire configured to be scanned by means of an electronically reading device by a user as the wearable attire is brought into its proximity, a data processing device configured to subsequently process the information and data pertaining to the wearable attire, received by scanning the electronically readable identifier embedded on the wearable attire, and a software application configured to support a user profile of the user. The disclosed system further comprises claiming ownership of the wearable attire by multiple consecutive scanning of the electronically readable identifier embedded on the wearable attire and signing into the software application.

According to an embodiment of the present disclosure, the means of an electronically reading device is a cellphone (smartphone). The user can use his cellphone for scanning the embedded electronically readable identifier on the wearable attire.

According to an embodiment of the present disclosure, the electronically readable identifier on the wearable attire is a QR code or an RFID tag.

According to an embodiment of the present disclosure, the wearable attire having the electronically readable identifier can be tracked on a blockchain or in a cloud database.

Embodiments of the present invention will be described below in detail with reference to the accompanying drawings.

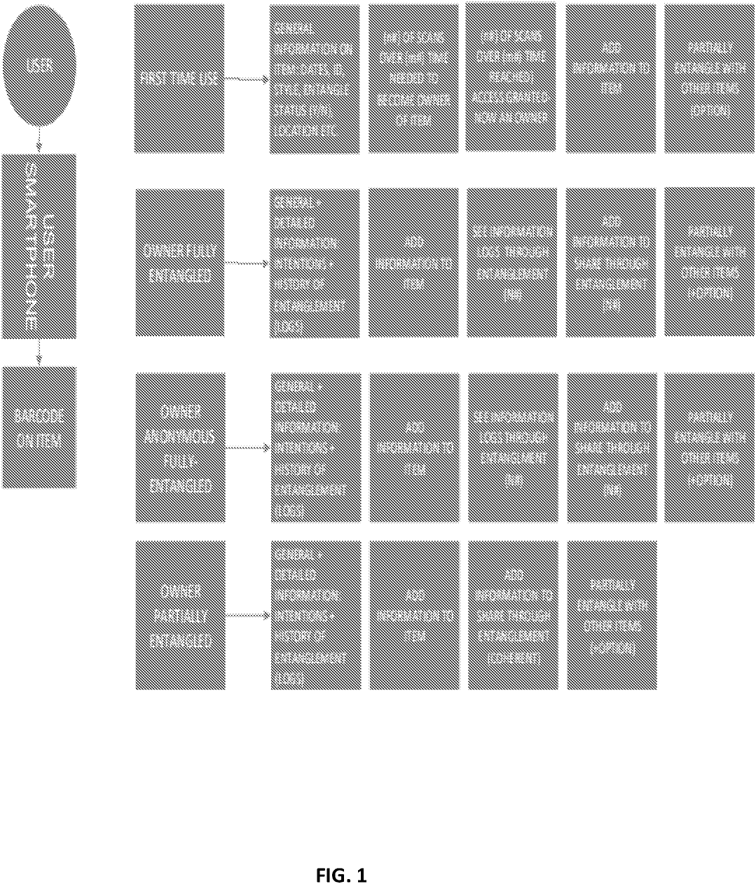

FIG. 1 illustrates a flow diagram outlining the system and user approaches and procedures of an embodiment of the present invention. This pictorial diagram of this embodiment of the present invention is comprised of the processes the user will encounter within various stages of ownership. The visual display illustrates the application processes and actions in one embodiment that allows the user to setup the ownership and data input, as well as achieve entanglement. The wearable attire utilized with the application is embedded with sensors, QR codes, processing ability, software, and other technologies that connect and exchange data with other devices and systems over the internet or other communication networks. This allows the user of the app to be more aware of the intention of their clothing, entanglement, location, and origin.

The concept of entanglement is that any wearable attire that comes in pairs can be shared between two people and/or become a one-off scenario. For instance, one sock can be purchased allowing an unknown buyer to purchase the other sock. Each individual knows that someone in the world holds the other sock. The one-off sock can be worn with any other non-related sock, making it a one-off, or mismatched pair. Another example is a friend who purchases two pairs and gives another friend the other pair, honoring their friendship. However, entanglement may be achieved within other situations as well. Not only can entanglement be executed between the individual and paired items, but it can also be established between items that belong in sets. Some examples may include his and her sets, bra, and panty sets, team jerseys, etc. The above description outlines the preferred embodiment of entanglement, but is not limited or restricted to these representations and interpretations alone.

The application will provide the wearer the ability to scan the stitched and/or embedded label and/or code attached to the wearable attire using their smartphone. The label and/or code will contain information about the wearable attire such as the intention, heritage (history), coherency with other attire, date purchased, customizable information, date created, location, lineage, unique wearable attire identification, and positive words of affirmation.

There are three separate stages or levels of entanglement: owner fully entangled, owner partially entangled, and owner anonymous fully entangled. The first level, i.e., owner fully entangled, means that the wearable attire purchased was entangled at creation by one owner. Entanglement is not an option, as the items will always be entangled. This level also provides the option to partially entangle with other items.

The second level, i.e., owner partially entangled, means that the wearable attire purchased was not entangled at creation, yet the owners can still decide to be coherent and send information to chosen partially entangled items. For this level, entanglement is an option and can be turned on or off. This level provides the option to partially entangle with other items, but logs will not be shared because the items are not fully entangled.

The third level, i.e., owner anonymous fully entangled, means that the wearable attire purchased was entangled at creation, with two different owners (buyers). Owners purchase one entangled item, knowing that someone (anonymous), who they may or may not know, will purchase the other entangled item. This level also provides the option to partially entangle with other items.

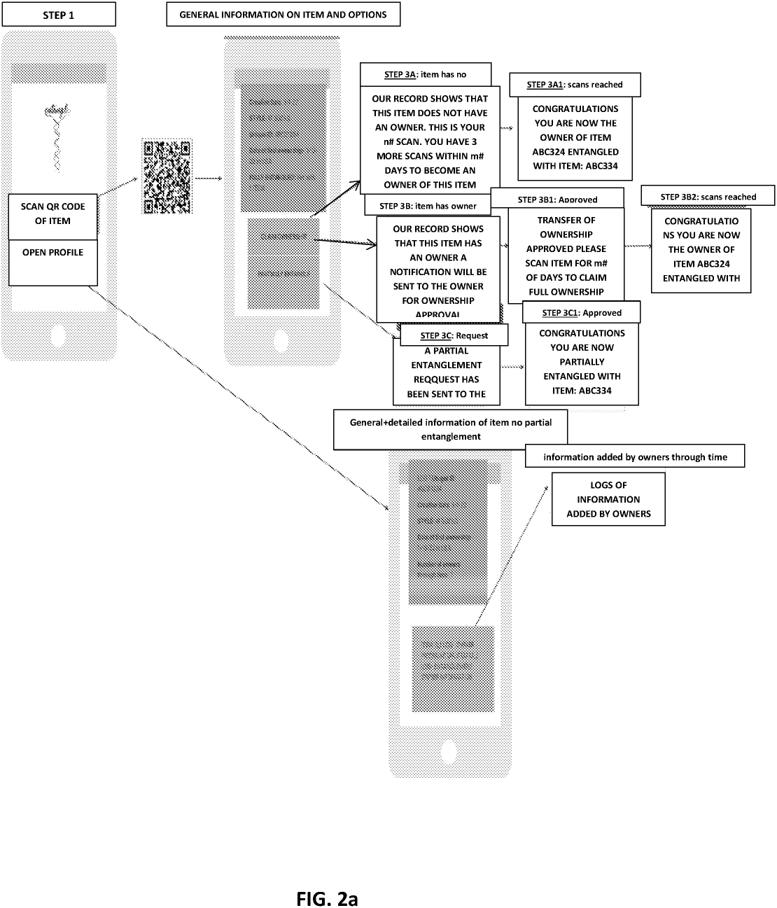

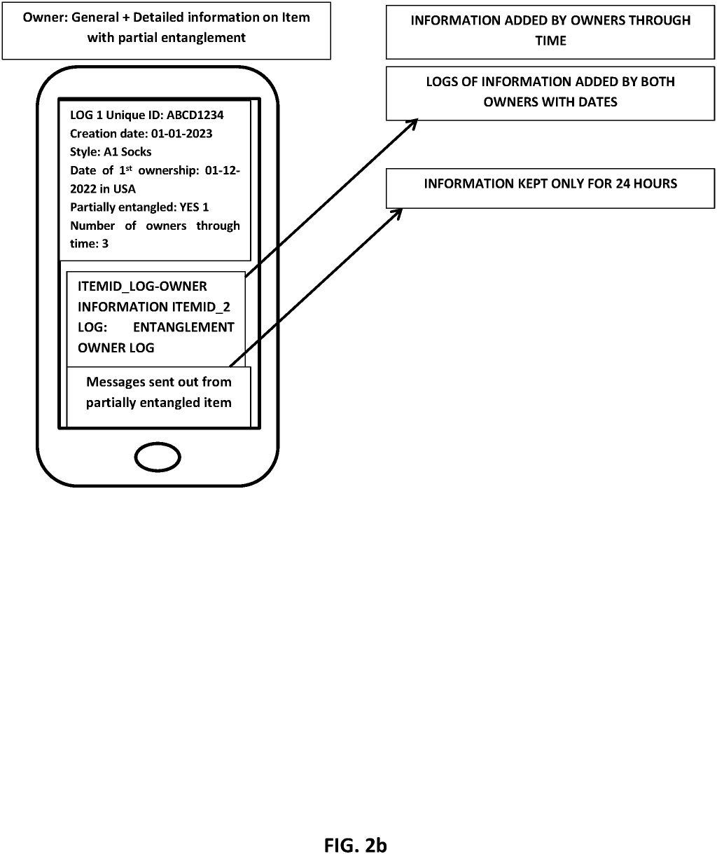

FIGS. 2a-2b illustrates a flow diagram outlining the system and user approaches and procedures of an embodiment of the present invention. This pictorial diagram of this embodiment of the present invention is comprised of the processes the user will encounter within various stages of ownership. The visual display illustrates the application processes and actions in one embodiment that allows the user to setup the ownership and data input, as well as achieve entanglement. This embodiment of the present invention is comprised of all the same elements and features in FIG. 1. All aspects and elements outlined in FIG. 1, and all other descriptions, are applicable to FIGS. 2a-2b. This embodiment of the present invention also illustrates the different processes of taking ownership of wearable attire, and of setting up partial entanglement.

In order for an owner to claim ownership, the individual must scan the label and/or code a certain number of times (n#) over a certain period of time (m#). If there is already an owner, a notification is sent to the original owner who can accept it or block it. If a user can show control through a specific number of scans (n#) over a specific period of time (m#), the individual can control the item and see its intentions, heritage (history), date purchased, date created, entanglement, coherency, lineage, customizable information, unique identification, positive words of affirmation, or any customizable information the owner adds. Each item has a unique identifier and when the label and/or code is scanned, new information can be added to that item as long as the user has claimed ownership from the specific number of scans (n#) in a specific amount of time (m#).

To complete partial entanglement, an owner can scan the label and/or code of the item they want to entangle with. A request will then be sent to the owner of the item, in which the individual will receive a notification and must agree to partial entanglement via the application.

### General Definitions

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments ± 100%, in some embodiments ± 50%, in some embodiments ± 20%, in some embodiments ± 10%, in some embodiments ± 5%, in some embodiments ± 1%, in some embodiments ± 0.5%, and in some embodiments ± 0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

1. A method for sharing information of a wearable attire, the method comprising:
providing an electronically readable identifier embedded on the wearable attire;
scanning, by means of an electronically reading device by a user, the electronically readable
identifier on the wearable attire as the wearable attire is brought into its proximity;
accessing, information and data pertaining to the wearable attire, by scanning the electronically readable identifier on the wearable attire;
providing the information and data pertaining to the wearable attire to a data processing device which subsequently processes said data;
creating a user profile, for the first-time user, on a software application on the electronically reading device;
signing, by the user, into the user profile on the software application; and
claiming ownership of the wearable attire by multiple consecutive scanning of the electronically readable identifier on the wearable attire.

2. The method as claimed in claim 1, comprising entangling the wearable attire of the user with the wearable attire of another user upon scanning the electronically readable identifier on the wearable attire of another user.

3. The method as claimed in claim 2, wherein scanning the electronically readable identifier on the wearable attire of another user comprising sending an entanglement request to another user of the wearable attire under the user profile on the software application of another user.

4. The method as claimed in any one of the preceding claims 2 or 3, comprising accepting the entanglement request by another user under the user profile on the software application for completing the entanglement of the two wearable attire.

5. The method as claimed in claim 2, wherein the method comprising entangling the wearable attire of the user with the wearable attire of another user by selecting the wearable attire out of an inventory under the user profile on the software application on the electronically reading device.

6. The method as claimed in claim 1, wherein the information and the data pertaining to the wearable attire comprises a unique identifier, a model, a size, measurements, a material and/or fabric, care instructions, a colour, a style and/or an origin of the wearable attire, entanglement status, user details, and historic record of data events associated with the wearable attire.

7. The method as claimed in claim 1, comprising claiming ownership of the wearable attire by entering a unique secret code, on the software application, associated with the wearable attire.

8. The method as claimed in claim 1, comprising preventing an adverse possession by locking the ownership of the wearable attire on the user profile.

9. The method as claimed in claim 1, comprising transferring the ownership of the wearable attire by selecting a transfer option on the software application or by scanning the electronically readable identifier on the wearable attire of another user and selecting the wearable attire for which the ownership has to be transferred.

10. A system for sharing information of a wearable attire, the system comprising:
an electronically readable identifier embedded on the wearable attire configured to be scanned by
means of an electronically reading device by a user as the wearable attire is brought into its proximity;
a data processing device configured to subsequently process the information and data pertaining to the wearable attire, received by scanning the electronically readable identifier embedded on the wearable attire;
a software application configured to support a user profile of the user; and
wherein the system comprises claiming ownership of the wearable attire by multiple consecutive scanning of the electronically readable identifier embedded on the wearable attire and signing into the software application.

11. The system as claimed in claim 10, wherein the means of an electronically reading device is a cellphone.

12. The system as claimed in claim 10, wherein the electronically readable identifier embedded on the wearable attire is a QR code or an RFID tag.

13. The system as claimed in claim 10, wherein the wearable attire having the electronically readable identifier can be tracked on a blockchain or in a cloud database.
